(19) United States
(12) Patent Application Publication
(10) Pub. No.: US 2026/0314629 A1
(43) Pub. Date: Oct. 15, 2026

(54) CARAMEL COMPOSITION

(71) Applicants: BUNGE LODERS CROKLAAN B.V., Wormerveer (NL); BUNGE SA, Geneva (CH)

(72) Inventors: Laura OLIVER HERNANDEZ, Wormerveer (NL); Ivana FRANCISCA, Wormerveer (NL); Imro 'T ZAND, Zaandam (NL); Jun MA, Zaandam (NL); Eija Marjatta PIIPSPA, Raisio (FI)

(21) Appl. No.: 19/484,473

(22) PCT Filed: May 16, 2024
(86) PCT No.: PCT/EP2024/063538

§ 371 Date: Nov. 14, 2025

(30) Foreign Application Priority Data
May 17, 2023 (EP) 23173922.8

(51) Int. Cl. A23G 3/32; A23D 7/01; A23G 3/40; A23G 3/42; A23G 3/46

(52) U.S. Cl. CPC A23G 3/32; A23D 7/011; A23G 3/40; A23G 3/42; A23G 3/46

(57) ABSTRACT

The invention relates to a caramel composition comprising a dairy milk source and/or a plant-based milk source; a carbohydrate; and a plant-based fat composition wherein the plant-based fat composition has: at most 40.0% by weight of oleic acid (C18:1); and from 17.5% to 49.5% by weight of total palmitic acid (C16:0) and stearic acid (C18:0); said percentages of acid referring to acids bound as acyl groups in glycerides of the plant-based fat composition and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 30.0% to 55.0%; at most 30.0% by weight of CN54 triglycerides; based on total triglycerides present in the plant-based fat composition. The invention also relates to a process for preparing a caramel product, a caramel product and use of the caramel product.

This invention relates to a caramel composition, a process of preparing a caramel product, a caramel product and a use of the caramel product in food products.

### BACKGROUND

Caramel is an orange-brown colored confectionery product produced by heat-treating a range of sugars. It can be used for preparing various confectionery products such as candy bars, topping for ice cream or frozen yoghurt, filling in snack bars or bonbons or flavoring in puddings, etc. Caramel is prepared by a process of caramelization involving heating sugar slowly to a high temperature in order to form a characteristic color and flavor.

Fats and oils are important ingredients of food products, including caramel, and used extensively in the food industry. Fats and oils play an important role of textural and organoleptic properties such as mouthfeel, texture, flavor release, flavor impact, processability and shelf life.

Butter fat is often used in caramel composition. Butter fat can have a negative impact on health since it contains about 3% trans fatty acid and significant amount of saturated fatty acid. Butter fat is also believed to have a negative impact on climate change and sustainability due to emission of carbon dioxide during its production.

However, it has been challenging to replace butter fat or any other animal origin fat in the fat composition of caramel products with a plant-based fat composition while still maintaining similar sensory and textural properties.

WO 2022/248490 relates to fat composition suitable for water-in-oil emulsion product such as margarine or spread. However, there is no disclosure of a caramel product with a plant-based fat composition.

There remains a need for a caramel product using a plant-based fat composition instead of butter fat while maintaining desirable textural and organoleptic properties such as viscosity, consistency, mouthfeel and flavour, compared to a conventional caramel product using butter fat. There is a further need for a caramel product using a plant-based fat composition without a high amount of flavour additives but yet having excellent sensory properties, similar to a caramel product using butter fat.

### DESCRIPTION OF THE INVENTION

According to the present invention, there is provided a caramel composition comprising a dairy milk source and/or a plant-based milk source; a carbohydrate; and a plant-based fat composition wherein the plant-based fat composition has: at most 40.0% by weight of oleic acid (C18:1); and from 17.5% to 49.5% by weight of total palmitic acid (C16:0) and stearic acid (C18:0); said percentages of acid referring to acids bound as acyl groups in glycerides of the plant-based fat composition and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 30.0% to 55.0%; at most 30.0% by weight of CN54 triglycerides; based on total triglycerides present in the plant-based fat composition.

It is believed that the plant-based fat composition of the caramel composition according to the invention with the specified triglyceride and fatty acid composition of both fat composition and the fatty acids located on the second position of the triglycerides in the fat composition plays an important role in the caramel product according to the invention having similar desirable sensory properties compared to conventional caramel products, such as those using butter fat.

As used herein, articles such as “a” and “an” when used in a claim, are understood to mean one or more of what is claimed or described.

The term “caramel” refers to an orange-brown colored confectionery product produced by heat-treating a range of sugars. The term “caramel composition” refers to a prepared composition suitable for making caramel. The term “caramel product” is used synonymously herein with “caramel”.

The term “dairy milk” refers to a white liquid emulsion beverage produced from mammals, as is well known. The term “plant-based milk”, which is also known as plant-based liquids, alternative milk, nut milk or vegan milk, and which is a plant juice that has similar appearance to dairy milk, and is also referred to as a manufactured, non-dairy beverage made from a water-based plant extract for flavoring and aroma. The water-based plant extract might be obtainable from plant material as such. Alternatively, the water-based plant extract might also be obtainable from plant material being treated to solubilize water-insoluble parts of the plant material which will subsequently be part of the water-based plant extract. Such treatment of the plant material could be performed enzymatically.

The term “carbohydrate” refers to biomolecule consisting of carbon, hydrogen and oxygen and is used synonymously herein with “saccharide”, including sugars, starch and cellulose.

The term “fat” refers to glyceride fats and oils containing fatty acid acyl groups and does not imply any particular melting point. The term “oil” is used herein synonymously with “fat”.

The term “fatty acid” refers to straight chain saturated or unsaturated (including mono- and poly unsaturated) carboxylic acids having from 8 to 24 carbon atoms. A fatty acid having x carbon atoms and y double bonds may be denoted Cx:y. For example, palmitic acid may be denoted C16:0 and oleic acid may be denoted C18:1. The fatty acid profile may be determined by fatty acid methyl ester analysis (FAME) using gas chromatography according to ISO 12966-2 and ISO 12966-4. Thus, percentages of fatty acids in compositions (e.g. palmitic acid (C16:0), stearic acid (C18:0), oleic acid (C18:1) etc.) referred to herein, unless otherwise stated, include both acyl groups such as tri-, di- and mono-glycerides and are based on the total weight of C8 to C24 fatty acid residues.

Triglyceride composition may be determined for example based on molecular weight differences (Carbon Number (CN)) by GC (AOCS Ce 5-86). The notation triglyceride CNxx denotes triglycerides having xx carbon atoms in the fatty acyl groups (thus excluding the carbon atoms from the glycerol, as is standard practice) e.g., CN54 includes tristearin. Amounts of triglycerides specified with each carbon number (CN), as is customary terminology in the art, are percentages by weight based on total triglycerides of CN26 to CN62 present in the fat composition.

SN-2 of total palmitic acid and stearic acid % refers to the percentage of total palmitic acid (C16:0) and stearic acid (C18:0) present at the 2-position of the triglyceride in comparison to the percentage of total palmitic acid (C16:0) and stearic acid (C18:0) in the fat sample. The distribution of fatty acids in triglyceride is determined based on joint JOCS/AOCS official method Ch 3a-19. The percentage of total palmitic acid (C16:0) and stearic acid (C18:0) residues in the 2-position is determined by finding: (a) the total palmitic acid (C16:0) and stearic acid (C18:0) content of the fat sample by GC-FAME (ISO 12966-2:2014 and ISO 12966-4:2015) being based on the total weight of C8 to C24 fatty acids; and (b) the total palmitic acid (C16:0) and stearic acid (C18:0) content of the 2-position by GC-FAME (ISO 12966-2:2014 and ISO 12966-4:2015) in 2-monoglyceride being based on the total weight of C8 to C24 fatty acids after the transesterification reaction of triacylglycerols with ethanol by immobilized lipase and the isolation with preparative straight phase HPLC. The Sn-2 of total palmitic acid and stearic acid % is thus ((b)×100)/((a)×3) %.

The plant-based fat composition of the caramel composition according to the invention is not, and is not derived from, one or more or animal fats. The plant-based fat composition of the caramel composition according to the invention may be made from naturally occurring (i.e. in plants or other non-animal sources) or synthetic fats, fractions of naturally occurring or synthetic fats, or mixtures thereof, that satisfy the requirements defined herein.

It is also preferred that the plant-based fat composition of the caramel composition according to the invention is, or is derived from non-hydrogenated fats. The term “non-hydrogenated” means that the fat composition is not prepared from a fat that has been subjected to hydrogenation to convert unsaturated fatty acyl groups to saturated fatty acyl groups.

The caramel composition according to the invention preferably comprises from 5% to 50% by weight of a dairy milk source and/or a plant-based milk source, more preferably from 15% to 45% by weight, even more preferably from 20% to 40% by weight and most preferably from 25% to 40% by weight.

In another preferred aspect, the caramel composition according to the invention comprises from 5% to 50% by weight of a combination of a dairy milk source and a plant-based milk source, more preferably from 15% to 45% by weight, even more preferably from 20% to 40% by weight and most preferably from 25% to 40% by weight. It is further desirable to substitute dairy milk source partially or fully with plant-based milk source to limit the use of dairy materials and eventually to produce a complete plant-based caramel composition and caramel product.

The caramel composition according to the invention preferably comprises from 5% to 80% by weight of a carbohydrate, more preferably from 10% to 70% by weight, even more preferably from 25% to 60% by weight and most preferably from 40% to 50% by weight.

The caramel composition according to the invention preferably comprises from 3% to 25% by weight the plant-based fat composition as disclosed herein, more preferably from 5% to 23% by weight, even more preferably from 8% to 21% by weight and most preferably from 12% to 19% by weight.

In a preferred aspect, the caramel composition according to the invention comprises from 5% to 50% by weight of a dairy milk source and/or a plant-based milk source; from 5% to 80% by weight of a carbohydrate; and from 3% to 25% by weight the plant-based fat composition as disclosed herein.

In a more preferred aspect, the caramel composition according to the invention comprises from 15% to 45% by weight of a dairy milk source and/or a plant-based milk source; from 10% to 70% by weight of a carbohydrate; and from 5% to 23% by weight the plant-based fat composition as disclosed herein.

In an even more preferred aspect, the caramel composition according to the invention comprises from 20% to 40% by weight of a dairy milk source and/or a plant-based milk source; from 25% to 60% by weight of a carbohydrate; and from 8% to 21% by weight the plant-based fat composition as disclosed herein.

In a most preferred aspect, the caramel composition according to the invention comprises from 25% to 40% by weight of a dairy milk source and/or a plant-based milk source; from 40% to 50% by weight of a carbohydrate; and from 12% to 19% by weight the plant-based fat composition as disclosed herein.

In a preferred aspect, the dairy milk source of the caramel composition according to the invention is selected from a group consisting of whole milk, skimmed milk, butter milk, condensed milk, milk drink, reconstituted milk, evaporated milk, cream, heavy cream, light cream, double cream, derivatives thereof and mixtures thereof. The terms “milk drink” and “reconstituted milk” may refer to milk powder and water either combined prior to making the caramel composition according to the invention or separately present in the caramel composition according to the invention. In a more preferred aspect, the dairy milk source of the caramel composition according to the invention is selected from a group consisting of condensed milk, evaporated milk, cream, derivatives thereof and mixtures thereof. In a more preferred aspect, the dairy milk source of the caramel composition according to the invention is condensed milk. It is preferred that the airy milk source has a fat content of less than 10% by weight and more preferably at most 9% by weight.

In another preferred aspect, the plant-based milk source of the caramel composition according to the invention is selected from a group consisting of almond milk, soy milk, coconut milk, rice milk, oat milk, hemp milk, pea milk, peanut milk, cashew milk, triticale milk, wheat milk, barley milk, spelt milk, millet milk, derivatives thereof and mixtures thereof. The plant-based milk source may be prepared and/or reconstituted by blending plant-based milk powder and water. In another more preferred aspect, the plant-based milk source of the caramel composition according to the invention is selected from a group consisting of oat milk, rice milk, derivatives thereof and mixtures thereof. In another even more preferred aspect, the plant-based milk source of the caramel composition according to the invention is oat milk.

The carbohydrate of the caramel composition according to the invention is preferably selected from a group consisting of fructose, glucose, sucrose, maltose, starch, syrup thereof, derivatives thereof and mixtures thereof, more preferably selected from a group consisting of fructose, glucose, syrup thereof, derivatives thereof and mixtures thereof.

The caramel composition according to the invention preferably further comprises from 1% to 10% by weight of a sugar alcohol, more preferably from 2% to 8% by weight, even more preferably from 3% to 7% by weight and most preferably from 4% to 6% by weight. The term “sugar alcohol”, also known as “polyalcohol”, refers to organic compounds containing a hydroxyl group (—OH) attached to each carbon atom, typically derived from sugars. The suitable sugar alcohol may include sorbitol, maltitol, mannitol, xylitol, erythritol, inositol, arabitol, glycerol, isomalt, lactitol, syrup thereof, derivatives thereof and mixtures thereof. Preferably, the caramel composition according to the invention preferably further comprises from 1% to 10% by weight of a sugar alcohol selected from a group consisting of sorbitol, maltitol, mannitol, syrup thereof, derivatives thereof and mixtures thereof. More preferably, the caramel composition according to the invention further comprises from 2% to 8% by weight a sugar alcohol selected from a group consisting of sorbitol, maltitol, syrup thereof, derivatives thereof and mixtures thereof. Even more preferably, the caramel composition according to the invention further comprises from 3% to 7% by weight of sorbitol and/or sorbitol syrup. Most preferably, the caramel composition according to the invention further comprises from 4% to 6% by weight of sorbitol and/or sorbitol syrup.

The caramel composition according to the invention preferably further comprises one or more ingredients selected from emulsifier, vanillin, salt, sodium bicarbonate, calcium carbonate, colorant and flavoring. The caramel composition according to the invention more preferably further comprises an emulsifier selected from a group consisting of lecithin, mono- and diglyceride, distilled monoglyceride, derivatives thereof and mixtures thereof. The term “lecithin” used herein includes natural lecithin or modified lecithin such as hydrolyzed lecithin.

Non-limiting examples of the sources of lecithin are soybean, rapeseed, cottonseed, sunflower, egg yolk and milk. The plant-based sources of lecithin are particularly preferred.

The caramel composition according to the invention preferably further comprises at most 0.20% by weight of butter flavoring, more preferably at most 0.05% by weight, even more preferably at most 0.02% by weight and most preferably from 0.005% to 0.015% by weight.

The caramel composition according to the invention preferably further comprises at most 1.0% by weight of lecithin, more preferably from 0.05% to 0.8% by weight, even more preferably from 0.1% to 0.6% by weight and most preferably from 0.2% to 0.4% by weight. The lecithin disclosed herein is preferably sunflower lecithin.

In a preferred aspect, the caramel composition according to the invention comprises from 5% to 50% by weight of a dairy milk source selected from a group consisting of whole milk, skimmed milk, butter milk, condensed milk, milk drink, reconstituted milk, evaporated milk, cream, heavy cream, light cream, double cream, derivatives thereof and mixtures thereof; from 5% to 80% by weight of a carbohydrate selected from a group consisting of fructose, glucose, sucrose, maltose, starch, syrup thereof, derivatives thereof and mixtures thereof; and from 3% to 25% by weight the plant-based fat composition as disclosed herein.

In a more preferred aspect, the caramel composition according to the invention comprises from 15% to 45% by weight of a dairy milk source selected from a group consisting of condensed milk, evaporated milk, cream, derivatives thereof and mixtures thereof; from 10% to 70% by weight of a carbohydrate selected from a group consisting of fructose, glucose, sucrose, maltose, starch, syrup thereof, derives thereof and mixture thereof; and from 5% to 23% by weight the plant-based fat composition as disclosed herein.

In an even more preferred aspect, the caramel composition according to the invention comprises from 20% to 40% by weight of a dairy milk source selected from a group consisting of condensed milk, evaporated milk, cream, derivatives thereof and mixtures thereof; from 25% to 60% by weight of a carbohydrate selected from a group consisting of fructose, glucose, syrup thereof, derivatives thereof and mixtures thereof; and from 8% to 21% by weight the plant-based fat composition as disclosed herein.

In a most preferred aspect, the caramel composition according to the invention comprises from 25% to 40% by weight of a dairy milk source which is condensed milk; from 40% to 50% by weight of a carbohydrate selected from a group consisting of fructose, glucose, syrup thereof, derivatives thereof and mixtures thereof; and from 12% to 19% by weight the plant-based fat composition as disclosed herein.

In another preferred aspect, the caramel composition according to the invention comprises from 5% to 50% by weight of a plant-based milk source selected from a group consisting of almond milk, soy milk, coconut milk, rice milk, oat milk, hemp milk, pea milk, peanut milk, cashew milk, triticale milk, wheat milk, barley milk, spelt milk, millet milk, derivatives thereof and mixtures thereof; from 5% to 80% by weight of a carbohydrate selected from a group consisting of fructose, glucose, sucrose, maltose, starch, syrup thereof, derivatives thereof and mixtures thereof; and from 3% to 25% by weight the plant-based fat composition as disclosed herein.

In another more preferred aspect, the caramel composition according to the invention comprises from 15% to 45% by weight of a plant-based milk source selected from a group consisting of almond milk, soy milk, coconut milk, rice milk, oat milk, hemp milk, pea milk, peanut milk, cashew milk, triticale milk, wheat milk, barley milk, spelt milk, millet milk, derivatives thereof and mixtures thereof; from 10% to 70% by weight of a carbohydrate selected from a group consisting of fructose, glucose, sucrose, maltose, starch, syrup thereof, derivatives thereof and mixtures thereof; and from 5% to 23% by weight the plant-based fat composition as disclosed herein.

In another even more preferred aspect, the caramel composition according to the invention comprises from 20% to 40% by weight of a plant-based milk source selected from a group consisting of oat milk, rice milk, derivatives thereof and mixtures thereof; from 25% to 60% by weight of a carbohydrate selected from a group consisting of fructose, glucose, syrup thereof, derivatives thereof and mixtures thereof; and from 8% to 21% by weight the plant-based fat composition as disclosed herein.

In another most preferred aspect, the caramel composition according to the invention comprises from 25% to 40% by weight of a plant-based milk source which is oat milk; from 40% to 50% by weight of a carbohydrate selected from a group consisting of fructose, glucose, syrup thereof, derivatives thereof and mixtures thereof; and from 12% to 19% by weight the plant-based fat composition as disclosed herein.

In a preferred aspect, the caramel composition according to the invention comprises from 5% to 50% by weight of a dairy milk source selected from a group consisting of whole milk, skimmed milk, butter milk, condensed milk, milk drink, reconstituted milk, evaporated milk, cream, heavy cream, light cream, double cream, derivatives thereof and mixtures thereof; from 5% to 80% by weight of a carbohydrate selected from a group consisting of fructose, glucose, sucrose, maltose, starch, syrup thereof, derivatives thereof and mixtures thereof; from 1% to 10% by weight of a sugar alcohol; from 3% to 25% by weight the plant-based fat composition as disclosed herein; at most 0.20% by weight of butter flavoring; and at most 1.0% by weight of lecithin.

In a more preferred aspect, the caramel composition according to the invention comprises from 15% to 45% by weight of a dairy milk source selected from a group consisting of condensed milk, evaporated milk, cream, derivatives thereof and mixtures thereof; from 10% to 70% by weight of a carbohydrate selected from a group consisting of fructose, glucose, sucrose, maltose, starch, syrup thereof, derivatives thereof and mixtures thereof; from 2% to 8% by weight of a sugar alcohol; from 5% to 23% by weight the plant-based fat composition as disclosed herein; at most 0.05% by weight of butter flavoring; and from 0.05% to 0.8% by weight of lecithin.

In an even more preferred aspect, the caramel composition according to the invention comprises from 20% to 40% by weight of a dairy milk source selected from a group consisting of condensed milk, evaporated milk, cream, derivatives thereof and mixtures thereof; from 25% to 60% by weight of a carbohydrate selected from a group consisting of fructose, glucose, syrup thereof, derivatives thereof and mixtures thereof; from 3% to 7% by weight of a sugar alcohol; from 8% to 21% by weight the plant-based fat composition as disclosed herein; at most 0.02% by weight of butter flavoring; and from 0.1% to 0.6% by weight of lecithin.

In a most preferred aspect, the caramel composition according to the invention comprises from 25% to 40% by weight of a dairy milk source which is condensed milk; from 40% to 50% by weight of a carbohydrate selected from a group consisting of fructose, glucose, syrup thereof, derivatives thereof and mixtures thereof; from 4% to 6% by weight of a sugar alcohol; from 12% to 19% by weight the plant-based fat composition as disclosed herein; from 0.005% to 0.015% by weight of butter flavoring; and from 0.2% to 0.4% by weight of sunflower lecithin.

In another preferred aspect, the caramel composition according to the invention comprises from 5% to 50% by weight of a plant-based milk source selected from a group consisting of almond milk, soy milk, coconut milk, rice milk, oat milk, hemp milk, pea milk, peanut milk, cashew milk, triticale milk, wheat milk, barley milk, spelt milk, millet milk, derivatives thereof and mixtures thereof; from 5% to 80% by weight of a carbohydrate selected from a group consisting of fructose, glucose, sucrose, maltose, starch, syrup thereof, derivatives thereof and mixtures thereof; from 1% to 10% by weight of a sugar alcohol; from 3% to 25% by weight the plant-based fat composition as disclosed herein; at most 0.20% by weight of butter flavoring; and at most 1.0% by weight of lecithin.

In another more preferred aspect, the caramel composition according to the invention comprises from 15% to 45% by weight of a plant-based milk source selected from a group consisting of almond milk, soy milk, coconut milk, rice milk, oat milk, hemp milk, pea milk, peanut milk, cashew milk, triticale milk, wheat milk, barley milk, spelt milk, millet milk, derivatives thereof and mixtures thereof; from 10% to 70% by weight of a carbohydrate selected from a group consisting of fructose, glucose, sucrose, maltose, starch, syrup thereof, derivatives thereof and mixtures thereof; from 2% to 8% by weight of a sugar alcohol; from 5% to 23% by weight the plant-based fat composition as disclosed herein; at most 0.05% by weight of butter flavoring; and from 0.05% to 0.8% by weight of lecithin.

In another even more preferred aspect, the caramel composition according to the invention comprises from 20% to 40% by weight of a plant-based milk source selected from a group consisting of oat milk, rice milk, derivatives thereof and mixtures thereof; from 25% to 60% by weight of a carbohydrate selected from a group consisting of fructose, glucose, syrup thereof, derivatives thereof and mixtures thereof; from 3% to 7% by weight of a sugar alcohol; from 8% to 21% by weight the plant-based fat composition as disclosed herein; at most 0.02% by weight of butter flavoring; and from 0.1% to 0.6% by weight of lecithin.

In another most preferred aspect, the caramel composition according to the invention comprises from 25% to 40% by weight of a plant-based milk source which is oat milk; from 40% to 50% by weight of a carbohydrate selected from a group consisting of fructose, glucose, syrup thereof, derivatives thereof and mixtures thereof; from 4% to 6% by weight of a sugar alcohol; from 12% to 19% by weight the plant-based fat composition as disclosed herein; from 0.005% to 0.015% by weight of butter flavoring; and from 0.2% to 0.4% by weight of sunflower lecithin.

The plant-based fat composition of the caramel composition according to the invention preferably has from 1.0% to 35.0% by weight of lauric acid (C12:0), more preferably from 2.0% to 30.0% by weight, even more preferably from 3.0% to 28.0% by weight and most preferably from 4.0% to 26.0% by weight; said percentages of acid referring to acids bound as acyl groups in glycerides of the plant-based fat composition and being based on the total weight of C8 to C24 fatty acids.

The plant-based fat composition of the caramel composition according to the invention preferably has from 1.0% to 15.0% by weight of myristic acid (C14:0), more preferably from 1.5% to 13.0% by weight, even more preferably from 2.0% to 11.0% by weight and most preferably from 2.5% to 10.0% by weight; said percentages of acid referring to acids bound as acyl groups in glycerides of the plant-based fat composition and being based on the total weight of C8 to C24 fatty acids.

The plant-based fat composition of the caramel composition according to the invention preferably has from 5.0% to 50.0% by weight of palmitic acid (C16:0), more preferably from 7.0% to 48.0% by weight, even more preferably from 7.0% to 45.0% by weight and most preferably from 7.0% to 42.0% by weight; said percentages of acid referring to acids bound as acyl groups in glycerides of the plant-based fat composition and being based on the total weight of C8 to C24 fatty acids.

The plant-based fat composition of the caramel composition according to the invention preferably has from 3.0% to 25.0% by weight of stearic acid (C18:0), more preferably from 4.0% to 20.0% by weight, even more preferably from 4.2% to 18.0% by weight and most preferably from 4.5% to 17.0% by weight; said percentages of acid referring to acids bound as acyl groups in glycerides of the plant-based fat composition and being based on the total weight of C8 to C24 fatty acids.

The plant-based fat composition of the caramel composition according to the invention preferably has from 18.0% to 48.0% by weight of total palmitic acid (C16:0) and stearic acid (C18:0), more preferably from 18.0% to 47.0% by weight, even more preferably from 18.0% to 46.0% by weight and most preferably from 18.0% to 45.0% by weight; said percentages of acid referring to acids bound as acyl groups in glycerides of the plant-based fat composition and being based on the total weight of C8 to C24 fatty acids.

The plant-based fat composition of the caramel composition according to the invention preferably has from 20.0% to 39.0% by weight of oleic acid (C18:1), more preferably from 25.0% to 38.5% by weight, even more preferably from 30.0% to 38.5% by weight and most preferably from 33.0% to 38.5% by weight; said percentages of acid referring to acids bound as acyl groups in glycerides of the plant-based fat composition and being based on the total weight of C8 to C24 fatty acids.

The plant-based fat composition of the caramel composition according to the invention preferably has at most 12.0% by weight of linoleic acid (C18:2), more preferably from 1.0% to 10.0% by weight, even more preferably from 2.0% to 9.5% by weight and most preferably from 3.0% to 9.5% by weight; said percentages of acid referring to acids bound as acyl groups in glycerides of the plant-based fat composition and being based on the total weight of C8 to C24 fatty acids.

In a preferred aspect, the plant-based fat composition of the caramel composition according to the invention has from 1.0% to 35.0% by weight of lauric acid (C12:0); from 1.0% to 15.0% by weight of myristic acid (C14:0); from 5.0% to 50.0% by weight of palmitic acid (C16:0); from 3.0% to 25.0% by weight of stearic acid (C18:0); from 18.0% to 48.0% by weight of total palmitic acid (C16:0) and stearic acid (C18:0); from 20.0% to 39.0% by weight of oleic acid (C18:1); and at most 12.0% by weight of linoleic acid (C18:2); said percentages of acid referring to acids bound as acyl groups in glycerides of the plant-based fat composition and being based on the total weight of C8 to C24 fatty acids.

In a more preferred aspect, the plant-based fat composition of the caramel composition according to the invention has from 2.0% to 30.0% by weight of lauric acid (C12:0); from 1.5% to 13.0% by weight of myristic acid (C14:0); from 7.0% to 48.0% by weight of palmitic acid (C16:0); from 4.0% to 20.0% by weight of stearic acid (C18:0); from 18.0% to 47.0% by weight of total palmitic acid (C16:0) and stearic acid (C18:0); from 25.0% to 38.5% by weight of oleic acid (C18:1); and from 1.0% to 10.0% by weight of linoleic acid (C18:2); said percentages of acid referring to acids bound as acyl groups in glycerides of the plant-based fat composition and being based on the total weight of C8 to C24 fatty acids.

In an even more preferred aspect, the plant-based fat composition of the caramel composition according to the invention has from 3.0% to 28.0% by weight of lauric acid (C12:0); from 2.0% to 11.0% by weight of myristic acid (C14:0); from 7.0% to 45.0% by weight of palmitic acid (C16:0); from 4.2% to 18.0% by weight of stearic acid (C18:0); from 18.0% to 46.0% by weight of total palmitic acid (C16:0) and stearic acid (C18:0); from 30.0% to 38.5% by weight of oleic acid (C18:1); and from 2.0% to 9.5% by weight of linoleic acid (C18:2); said percentages of acid referring to acids bound as acyl groups in glycerides of the plant-based fat composition and being based on the total weight of C8 to C24 fatty acids.

In a most preferred aspect, the plant-based fat composition of the caramel composition according to the invention has from 4.0% to 26.0% by weight of lauric acid (C12:0); from 2.5% to 10.0% by weight of myristic acid (C14:0); from 7.0% to 42.0% by weight of palmitic acid (C16:0); from 4.5% to 17.0% by weight of stearic acid (C18:0); from 18.0% to 45.0% by weight of total palmitic acid (C16:0) and stearic acid (C18:0); from 33.0% to 38.5% by weight of oleic acid (C18:1); and from 3.0% to 9.5% by weight of linoleic acid (C18:2); said percentages of acid referring to acids bound as acyl groups in glycerides of the plant-based fat composition and being based on the total weight of C8 to C24 fatty acids.

The plant-based fat composition of the caramel composition according to the invention preferably has a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 32.0% to 50.0%, more preferably from 34.0% to 48.0%, even more preferably from 36.0% to 45.0% and most preferably from 37.0% to 43.0%.

The plant-based fat composition of the caramel composition according to the invention preferably has a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 10.0% to 35.0%, more preferably from 11.0% to 30.0%, even more preferably from 12.0% to 28.0% and most preferably from 12.5% to 26.5%.

The plant-based fat composition of the caramel composition according to the invention preferably has a percentage of oleic acid (C18:1) on the second position of triglycerides out of total oleic acid (C18:1) (Sn-2 oleic acid %) in the triglycerides of the plant-based fat composition of from 25.0% to 60.0%, more preferably from 28.0% to 55.0%, even more preferably from 30.0% to 53.0% and most preferably from 32.0% to 52.0%.

In a preferred aspect, the plant-based fat composition of the caramel composition according to the invention has a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 32.0% to 50.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 10.0% to 35.0%; and a percentage of oleic acid (C18:1) on the second position of triglycerides out of total oleic acid (C18:1) (Sn-2 oleic acid %) in the triglycerides of the plant-based fat composition of from 25.0% to 60.0%.

In a more preferred aspect, the plant-based fat composition of the caramel composition according to the invention has a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 34.0% to 48.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 11.0% to 30.0%; and a percentage of oleic acid (C18:1) on the second position of triglycerides out of total oleic acid (C18:1) (Sn-2 oleic acid %) in the triglycerides of the plant-based fat composition of from 28.0% to 55.0%.

In an even more preferred aspect, the plant-based fat composition of the caramel composition according to the invention has a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 36.0% to 45.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 12.0% to 28.0%; and a percentage of oleic acid (C18:1) on the second position of triglycerides out of total oleic acid (C18:1) (Sn-2 oleic acid %) in the triglycerides of the plant-based fat composition of from 30.0% to 53.0%.

In a most preferred aspect, the plant-based fat composition of the caramel composition according to the invention has a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 37.0% to 43.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 12.5% to 26.5%; and a percentage of oleic acid (C18:1) on the second position of triglycerides out of total oleic acid (C18:1) (Sn-2 oleic acid %) in the triglycerides of the plant-based fat composition of from 32.0% to 52.0%.

The plant-based fat composition of the caramel composition according to the invention preferably has a content of trans fatty acid residues of less than 1.0% by weight, more preferably less than 0.5% by weight, even more preferably less than 0.3% by weight and most preferably at most 0.2% by weight.

The plant-based fat composition of the caramel composition according to the invention preferably comprises from 45.0% to 75.0% by weight of saturated fatty acid (SAFA), more preferably from 47.0% to 70.0% by weight, even more preferably from 50.0% to 65.0% by weight and most preferably from 53.0% to 61.0% by weight.

The plant-based fat composition of the caramel composition according to the invention preferably comprises from 28.0% to 45.0% by weight of mono-unsaturated fatty acid (MUFA), more preferably from 30.0% to 43.0% by weight, even more preferably from 32.0% to 40.0% by weight and most preferably from 35.5% to 38.5% by weight.

The plant-based fat composition of the caramel composition according to the invention preferably comprises from 1.0% to 15.0% by weight of poly-unsaturated fatty acid (PUFA), more preferably from 2.0% to 13.0% by weight, even more preferably from 3.0% to 11.0% by weight and most preferably from 3.5% to 9.5% by weight.

As will be evident from the significant amounts of preferred mono-unsaturated and polyunsaturated fatty acid (MUFA and PUFA), preferably the plant-based fat composition of the caramel composition according to the invention, preferably the is non-hydrogenated.

The plant-based fat composition of the caramel composition according to the invention preferably has an iodine value of from 25 to 60, more preferably from 30 to 55, even more preferably from 35 to 50 and most preferably from 37 to 49. The term “iodine value” refers to the number of grams of iodine that could be added to 100 g of oil. Iodine value may be calculated according to AOCS Cd 1c-85 based on total acids bound as acyl groups in glycerides in the fat composition being based on the total weight of C8 to C24 fatty acids. Iodine value may alternatively be measured by AOCS Method Cd 1-25. The higher iodine value indicates a higher degree of unsaturation in a fat composition. The plant-based fat composition of the caramel composition according to the invention having a higher iodine value is even more preferred in order to obtain a lower saturated fatty acids content in the caramel composition lowering the cholesterol level while still maintaining desirable textural and organoleptic properties such as viscosity, consistency, mouthfeel and flavour.

The plant-based fat composition of the caramel composition according to the invention preferably has from 0.5% to 40.0% by weight of total CN32 triglycerides, CN34 triglycerides, CN36 triglycerides, CN38 triglycerides and CN40 triglycerides, more preferably from 1.0% to 39.0% by weight, even more preferably from 2.0% to 37.0% by weight and most preferably from 3.0% to 35.0% by weight; based on total triglycerides present in the plant-based fat composition.

The plant-based fat composition of the caramel composition according to the invention preferably has from 5.0% to 30.0% by weight of total CN44 triglycerides, CN46 triglycerides and CN48 triglycerides, more preferably from 10.0% to 29.0% by weight, even more preferably from 15.0% to 27.0% by weight and most preferably from 16.5% to 26.0% by weight; based on total triglycerides present in the plant-based fat composition.

The plant-based fat composition of the caramel composition according to the invention preferably has from 1.0% to 40.0% by weight of CN50 triglycerides, more preferably from 1.5% to 38.0% by weight, even more preferably from 2.0% to 35.0% and most preferably from 2.5% to 33.0% by weight; based on total triglycerides present in the plant-based fat composition.

The plant-based fat composition of the caramel composition according to the invention preferably has from 5.0% to 30.0% by weight of CN54 triglycerides, preferably from 6.0% to 29.0% by weight, more preferably from 8.0% to 28.0% by weight and even more preferably from 9.0% to 28.0%; based on total triglycerides present in the plant-based fat composition.

In a preferred aspect, the plant-based fat composition of the caramel composition according to the invention has from 0.5% to 40.0% by weight of total CN32 triglycerides, CN34 triglycerides, CN36 triglycerides, CN38 triglycerides and CN40 triglycerides; from 5.0% to 30.0% by weight of total CN44 triglycerides, CN46 triglycerides and CN48 triglycerides; from 1.0% to 40.0% by weight of CN50 triglycerides; and from 5.0% to 30.0% by weight of CN54 triglycerides; based on total triglycerides present in the plant-based fat composition.

In a more preferred aspect, the plant-based fat composition of the caramel composition according to the invention has from 1.0% to 39.0% by weight of total CN32 triglycerides, CN34 triglycerides, CN36 triglycerides, CN38 triglycerides and CN40 triglycerides; from 10.0% to 29.0% by weight of total CN44 triglycerides, CN46 triglycerides and CN48 triglycerides; from 1.5% to 38.0% by weight of CN50 triglycerides; and from 6.0% to 29.0% by weight of CN54 triglycerides; based on total triglycerides present in the plant-based fat composition.

In an even more preferred aspect, the plant-based fat composition of the caramel composition according to the invention has from 2.0% to 37.0% by weight of total CN32 triglycerides, CN34 triglycerides, CN36 triglycerides, CN38 triglycerides and CN40 triglycerides; from 15.0% to 27.0% by weight of total CN44 triglycerides, CN46 triglycerides and CN48 triglycerides; from 2.0% to 35.0% by weight of CN50 triglycerides; and from 8.0% to 28.0% by weight of CN54 triglycerides; based on total triglycerides present in the plant-based fat composition.

In a most preferred aspect, the plant-based fat composition of the caramel composition according to the invention has from 3.0% to 35.0% by weight of total CN32 triglycerides, CN34 triglycerides, CN36 triglycerides, CN38 triglycerides and CN40 triglycerides; from 16.5% to 26.0% by weight of total CN44 triglycerides, CN46 triglycerides and CN48 triglycerides; from 2.5% to 33.0% by weight of CN50 triglycerides; and from 9.0% to 28.0% by weight of CN54 triglycerides; based on total triglycerides present in the plant-based fat composition.

The plant-based fat composition of the caramel composition according to the invention preferably has from 40.0 to 50.0 solid fat content at 10° C., more preferably from 41.0 to 49.0, even more preferably from 42.0 to 48.0 and most preferably from 42.5 to 47.0; measured on unstabilized fat according to ISO 8292-1:2008.

The plant-based fat composition of the caramel composition according to the invention preferably has from 12.0 to 25.0 solid fat content at 20° C., preferably from 13.0 to 22.0, more preferably from 14.0 to 20.0 and even more preferably from 15.0 to 19.0; measured on unstabilized fat according to ISO 8292-1:2008.

The plant-based fat composition of the caramel composition according to the invention preferably has from 2.0 to 14.0 solid fat content at 25° C., preferably from 4.5 to 12.0, more preferably from 5.0 to 10.0 and even more preferably from 5.5 to 9.5; measured on unstabilized fat according to ISO 8292-1:2008.

The plant-based fat composition of the caramel composition according to the invention preferably has from 0.2 to 8.0 solid fat content at 30° C., preferably from 0.4 to 6.0, more preferably from 0.4 to 5.0 and even more preferably from 0.4 to 4.5; measured on unstabilized fat according to ISO 8292-1:2008.

In a preferred aspect, the plant-based fat composition of the caramel composition according to the invention has from 40.0 to 50.0 solid fat content at 10° C.; from 12.0 to 25.0 solid fat content at 20° C.; from 2.0 to 14.0 solid fat content at 25° C.; and from 0.2 to 8.0 solid fat content at 30° C.; measured on unstabilized fat according to ISO 8292-1:2008.

In a more preferred aspect, the plant-based fat composition of the caramel composition according to the invention has from 41.0 to 49.0 solid fat content at 10° C.; from 13.0 to 22.0 solid fat content at 20° C.; from 4.5 to 12.0 solid fat content at 25° C.; and from 0.4 to 6.0 solid fat content at 30° C.; measured on unstabilized fat according to ISO 8292-1:2008.

In an even more preferred aspect, the plant-based fat composition of the caramel composition according to the invention has from 42.0 to 48.0 solid fat content at 10° C.; from 14.0 to 20.0 solid fat content at 20° C.; from 5.0 to 10.0 solid fat content at 25° C.; and from 0.4 to 5.0 solid fat content at 30° C.; measured on unstabilized fat according to ISO 8292-1:2008.

In a most preferred aspect, the plant-based fat composition of the caramel composition according to the invention has from 42.5 to 47.0 solid fat content at 10° C.; from 15.0 to 19.0 solid fat content at 20° C.; from 5.5 to 9.5 solid fat content at 25° C.; and from 0.4 to 4.5 solid fat content at 30° C.; measured on unstabilized fat according to ISO 8292-1:2008.

The plant-based fat composition of the caramel composition according to the invention preferably has from 1.0% to 8.0% by weight of diglycerides, more preferably from 2.0% to 7.5% by weight and even more preferably from 2.5% to 7.0% by weight.

The plant-based fat composition of the caramel composition according to the invention preferably has at most 3.5% by weight of 1,2-diglycerides, more preferably from 0.1% to 3.0% by weight and even more preferably from 0.5% to 2.5% by weight.

The plant-based fat composition of the caramel composition according to the invention preferably has at most 6.0% by weight of 1,3-diglycerides, more preferably from 1.0% to 5.0% by weight and even more preferably from 1.9% to 4.5% by weight.

The term “diglyceride” refers to a glyceride consisting of two fatty acid chains covalently bonded to a glycerol molecule, not necessarily limited to specific positions on the glycerol backbone (1,3- or 2-positions). The term “1,2-diglyceride” refers to a glyceride consisting of two fatty acid chains covalently bonded to a glycerol molecule limited to 1,2 specific position on the glycerol backbone. The term “1,3-diglyceride” refers to a glyceride consisting of two fatty acid chains covalently bonded to a glycerol molecule limited to 1,3 specific position on the glycerol backbone.

In a preferred aspect, the caramel composition according to the invention comprises from 5% to 50% by weight of a dairy milk source selected from a group consisting of whole milk, skimmed milk, butter milk, condensed milk, milk drink, reconstituted milk, evaporated milk, cream, heavy cream, light cream, double cream, derivatives thereof and mixtures thereof; from 5% to 80% by weight of a carbohydrate selected from a group consisting of fructose, glucose, sucrose, maltose, starch, syrup thereof, derivatives thereof and mixtures thereof; from 1% to 10% by weight of a sugar alcohol; at most 0.20% by weight of butter flavoring; at most 1.0% by weight of lecithin; and from 3% to 25% by weight the plant-based fat composition having from 1.0% to 35.0% by weight of lauric acid (C12:0); from 1.0% to 15.0% by weight of myristic acid (C14:0); from 5.0% to 50.0% by weight of palmitic acid (C16:0); from 3.0% to 25.0% by weight of stearic acid (C18:0); from 18.0% to 48.0% by weight of total palmitic acid (C16:0) and stearic acid (C18:0); from 20.0% to 39.0% by weight of oleic acid (C18:1); and at most 12.0% by weight of linoleic acid (C18:2); said percentages of acid referring to acids bound as acyl groups in glycerides of the plant-based fat composition and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 32.0% to 50.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 10.0% to 35.0%; and a percentage of oleic acid (C18:1) on the second position of triglycerides out of total oleic acid (C18:1) (Sn-2 oleic acid %) in the triglycerides of the plant-based fat composition of from 25.0% to 60.0%; from 0.5% to 40.0% by weight of total CN32 triglycerides, CN34 triglycerides, CN36 triglycerides, CN38 triglycerides and CN40 triglycerides; from 5.0% to 30.0% by weight of total CN44 triglycerides, CN46 triglycerides and CN48 triglycerides; from 1.0% to 40.0% by weight of CN50 triglycerides; and from 5.0% to 30.0% by weight of CN54 triglycerides; based on total triglycerides present in the plant-based fat composition; from 40.0 to 50.0 solid fat content at 10° C.; from 12.0 to 25.0 solid fat content at 20° C.; from 2.0 to 14.0 solid fat content at 25° C.; and from 0.2 to 8.0 solid fat content at 30° C.; measured on unstabilized fat according to ISO 8292-1:2008.

In a more preferred aspect, the caramel composition according to the invention comprises from 15% to 45% by weight of a dairy milk source selected from a group consisting of condensed milk, evaporated milk, cream, derivatives thereof and mixtures thereof; from 10% to 70% by weight of a carbohydrate selected from a group consisting of fructose, glucose, sucrose, maltose, starch, syrup thereof, derivatives thereof and mixtures thereof; from 2% to 8% by weight of a sugar alcohol; at most 0.05% by weight of butter flavoring; from 0.05% to 0.8% by weight of lecithin; and from 5% to 23% by weight the plant-based fat composition having from 2.0% to 30.0% by weight of lauric acid (C12:0); from 1.5% to 13.0% by weight of myristic acid (C14:0); from 7.0% to 48.0% by weight of palmitic acid (C16:0); from 4.0% to 20.0% by weight of stearic acid (C18:0); from 18.0% to 47.0% by weight of total palmitic acid (C16:0) and stearic acid (C18:0); from 25.0% to 38.5% by weight of oleic acid (C18:1); and from 1.0% to 10.0% by weight of linoleic acid (C18:2); said percentages of acid referring to acids bound as acyl groups in glycerides of the plant-based fat composition and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 34.0% to 48.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 11.0% to 30.0%; and a percentage of oleic acid (C18:1) on the second position of triglycerides out of total oleic acid (C18:1) (Sn-2 oleic acid %) in the triglycerides of the plant-based fat composition of from 28.0% to 55.0%; from 1.0% to 39.0% by weight of total CN32 triglycerides, CN34 triglycerides, CN36 triglycerides, CN38 triglycerides and CN40 triglycerides; from 10.0% to 29.0% by weight of total CN44 triglycerides, CN46 triglycerides and CN48 triglycerides; from 1.5% to 38.0% by weight of CN50 triglycerides; and from 6.0% to 29.0% by weight of CN54 triglycerides; based on total triglycerides present in the plant-based fat composition; from 41.0 to 49.0 solid fat content at 10° C.; from 13.0 to 22.0 solid fat content at 20° C.; from 4.5 to 12.0 solid fat content at 25° C.; and from 0.4 to 6.0 solid fat content at 30° C.; measured on unstabilized fat according to ISO 8292-1:2008.

In an even more preferred aspect, the caramel composition according to the invention comprises from 20% to 40% by weight of a dairy milk source selected from a group consisting of condensed milk, evaporated milk, cream, derivatives thereof and mixtures thereof; from 25% to 60% by weight of a carbohydrate selected from a group consisting of fructose, glucose, syrup thereof, derivatives thereof and mixtures thereof; from 3% to 7% by weight of a sugar alcohol; at most 0.02% by weight of butter flavoring; from 0.1% to 0.6% by weight of lecithin; and from 8% to 21% by weight the plant-based fat composition having from 3.0% to 28.0% by weight of lauric acid (C12:0); from 2.0% to 11.0% by weight of myristic acid (C14:0); from 7.0% to 45.0% by weight of palmitic acid (C16:0); from 4.2% to 18.0% by weight of stearic acid (C18:0); from 18.0% to 46.0% by weight of total palmitic acid (C16:0) and stearic acid (C18:0); from 30.0% to 38.5% by weight of oleic acid (C18:1); and from 2.0% to 9.5% by weight of linoleic acid (C18:2); said percentages of acid referring to acids bound as acyl groups in glycerides of the plant-based fat composition and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 36.0% to 45.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 12.0% to 28.0%; and a percentage of oleic acid (C18:1) on the second position of triglycerides out of total oleic acid (C18:1) (Sn-2 oleic acid %) in the triglycerides of the plant-based fat composition of from 30.0% to 53.0%; from 2.0% to 37.0% by weight of total CN32 triglycerides, CN34 triglycerides, CN36 triglycerides, CN38 triglycerides and CN40 triglycerides; from 15.0% to 27.0% by weight of total CN44 triglycerides, CN46 triglycerides and CN48 triglycerides; from 2.0% to 35.0% by weight of CN50 triglycerides; and from 8.0% to 28.0% by weight of CN54 triglycerides; based on total triglycerides present in the plant-based fat composition; from 42.0 to 48.0 solid fat content at 10° C.; from 14.0 to 20.0 solid fat content at 20° C.; from 5.0 to 10.0 solid fat content at 25° C.; and from 0.4 to 5.0 solid fat content at 30° C.; measured on unstabilized fat according to ISO 8292-1:2008.

In a most preferred aspect, the caramel composition according to the invention comprises from 25% to 40% by weight of a dairy milk source which is condensed milk; from 40% to 50% by weight of a carbohydrate selected from a group consisting of fructose, glucose, syrup thereof, derivatives thereof and mixtures thereof; from 4% to 6% by weight of a sugar alcohol; from 0.005% to 0.015% by weight of butter flavoring; from 0.2% to 0.4% by weight of sunflower lecithin; and from 12% to 19% by weight the plant-based fat composition having from 4.0% to 26.0% by weight of lauric acid (C12:0); from 2.5% to 10.0% by weight of myristic acid (C14:0); from 7.0% to 42.0% by weight of palmitic acid (C16:0); from 4.5% to 17.0% by weight of stearic acid (C18:0); from 18.0% to 45.0% by weight of total palmitic acid (C16:0) and stearic acid (C18:0); from 33.0% to 38.5% by weight of oleic acid (C18:1); and from 3.0% to 9.5% by weight of linoleic acid (C18:2); said percentages of acid referring to acids bound as acyl groups in glycerides of the plant-based fat composition and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 37.0% to 43.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 12.5% to 26.5%; and a percentage of oleic acid (C18:1) on the second position of triglycerides out of total oleic acid (C18:1) (Sn-2 oleic acid %) in the triglycerides of the plant-based fat composition of from 32.0% to 52.0%; from 3.0% to 35.0% by weight of total CN32 triglycerides, CN34 triglycerides, CN36 triglycerides, CN38 triglycerides and CN40 triglycerides; from 16.5% to 26.0% by weight of total CN44 triglycerides, CN46 triglycerides and CN48 triglycerides; from 2.5% to 33.0% by weight of CN50 triglycerides; and from 9.0% to 28.0% by weight of CN54 triglycerides; based on total triglycerides present in the plant-based fat composition; from 42.5 to 47.0 solid fat content at 10° C.; from 15.0 to 19.0 solid fat content at 20° C.; from 5.5 to 9.5 solid fat content at 25° C.; and from 0.4 to 4.5 solid fat content at 30° C.; measured on unstabilized fat according to ISO 8292-1:2008.

In another preferred aspect, the caramel composition according to the invention comprises from 5% to 50% by weight of a plant-based milk source selected from a group consisting of almond milk, soy milk, coconut milk, rice milk, oat milk, hemp milk, pea milk, peanut milk, cashew milk, triticale milk, wheat milk, barley milk, spelt milk, millet milk, derivatives thereof and mixtures thereof; from 5% to 80% by weight of a carbohydrate selected from a group consisting of fructose, glucose, sucrose, maltose, starch, syrup thereof, derivatives thereof and mixtures thereof; from 1% to 10% by weight of a sugar alcohol; at most 0.20% by weight of butter flavoring; at most 1.0% by weight of lecithin; and from 3% to 25% by weight the plant-based fat composition having from 1.0% to 35.0% by weight of lauric acid (C12:0); from 1.0% to 15.0% by weight of myristic acid (C14:0); from 5.0% to 50.0% by weight of palmitic acid (C16:0); from 3.0% to 25.0% by weight of stearic acid (C18:0); from 18.0% to 48.0% by weight of total palmitic acid (C16:0) and stearic acid (C18:0); from 20.0% to 39.0% by weight of oleic acid (C18:1); and at most 12.0% by weight of linoleic acid (C18:2); said percentages of acid referring to acids bound as acyl groups in glycerides of the plant-based fat composition and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 32.0% to 50.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 10.0% to 35.0%; and a percentage of oleic acid (C18:1) on the second position of triglycerides out of total oleic acid (C18:1) (Sn-2 oleic acid %) in the triglycerides of the plant-based fat composition of from 25.0% to 60.0%; from 0.5% to 40.0% by weight of total CN32 triglycerides, CN34 triglycerides, CN36 triglycerides, CN38 triglycerides and CN40 triglycerides; from 5.0% to 30.0% by weight of total CN44 triglycerides, CN46 triglycerides and CN48 triglycerides; from 1.0% to 40.0% by weight of CN50 triglycerides; and from 5.0% to 30.0% by weight of CN54 triglycerides; based on total triglycerides present in the plant-based fat composition; from 40.0 to 50.0 solid fat content at 10° C.; from 12.0 to 25.0 solid fat content at 20° C.; from 2.0 to 14.0 solid fat content at 25° C.; and from 0.2 to 8.0 solid fat content at 30° C.; measured on unstabilized fat according to ISO 8292-1:2008.

In another more preferred aspect, the caramel composition according to the invention from 15% to 45% by weight of a plant-based milk source selected from a group consisting of almond milk, soy milk, coconut milk, rice milk, oat milk, hemp milk, pea milk, peanut milk, cashew milk, triticale milk, wheat milk, barley milk, spelt milk, millet milk, derivatives thereof and mixtures thereof; from 10% to 70% by weight of a carbohydrate selected from a group consisting of fructose, glucose, sucrose, maltose, starch, syrup thereof, derivatives thereof and mixtures thereof; from 2% to 8% by weight of a sugar alcohol; at most 0.05% by weight of butter flavoring; from 0.05% to 0.8% by weight of lecithin; and from 5% to 23% by weight the plant-based fat composition having from 2.0% to 30.0% by weight of lauric acid (C12:0); from 1.5% to 13.0% by weight of myristic acid (C14:0); from 7.0% to 48.0% by weight of palmitic acid (C16:0); from 4.0% to 20.0% by weight of stearic acid (C18:0); from 18.0% to 47.0% by weight of total palmitic acid (C16:0) and stearic acid (C18:0); from 25.0% to 38.5% by weight of oleic acid (C18:1); and from 1.0% to 10.0% by weight of linoleic acid (C18:2); said percentages of acid referring to acids bound as acyl groups in glycerides of the plant-based fat composition and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 34.0% to 48.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 11.0% to 30.0%; and a percentage of oleic acid (C18:1) on the second position of triglycerides out of total oleic acid (C18:1) (Sn-2 oleic acid %) in the triglycerides of the plant-based fat composition of from 28.0% to 55.0%; from 1.0% to 39.0% by weight of total CN32 triglycerides, CN34 triglycerides, CN36 triglycerides, CN38 triglycerides and CN40 triglycerides; from 10.0% to 29.0% by weight of total CN44 triglycerides, CN46 triglycerides and CN48 triglycerides; from 1.5% to 38.0% by weight of CN50 triglycerides; and from 6.0% to 29.0% by weight of CN54 triglycerides; based on total triglycerides present in the plant-based fat composition; from 41.0 to 49.0 solid fat content at 10° C.; from 13.0 to 22.0 solid fat content at 20° C.; from 4.5 to 12.0 solid fat content at 25° C.; and from 0.4 to 6.0 solid fat content at 30° C.; measured on unstabilized fat according to ISO 8292-1:2008.

In another even more preferred aspect, the caramel composition according to the invention comprises from 20% to 40% by weight of a plant-based milk source selected from a group consisting of oat milk, rice milk, derivatives thereof and mixtures thereof; from 25% to 60% by weight of a carbohydrate selected from a group consisting of fructose, glucose, syrup thereof, derivatives thereof and mixtures thereof; from 3% to 7% by weight of a sugar alcohol; at most 0.02% by weight of butter flavoring; from 0.1% to 0.6% by weight of lecithin; and from 8% to 21% by weight the plant-based fat composition having from 3.0% to 28.0% by weight of lauric acid (C12:0); from 2.0% to 11.0% by weight of myristic acid (C14:0); from 7.0% to 45.0% by weight of palmitic acid (C16:0); from 4.2% to 18.0% by weight of stearic acid (C18:0); from 18.0% to 46.0% by weight of total palmitic acid (C16:0) and stearic acid (C18:0); from 30.0% to 38.5% by weight of oleic acid (C18:1); and from 2.0% to 9.5% by weight of linoleic acid (C18:2); said percentages of acid referring to acids bound as acyl groups in glycerides of the plant-based fat composition and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 36.0% to 45.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 12.0% to 28.0%; and a percentage of oleic acid (C18:1) on the second position of triglycerides out of total oleic acid (C18:1) (Sn-2 oleic acid %) in the triglycerides of the plant-based fat composition of from 30.0% to 53.0%; from 2.0% to 37.0% by weight of total CN32 triglycerides, CN34 triglycerides, CN36 triglycerides, CN38 triglycerides and CN40 triglycerides; from 15.0% to 27.0% by weight of total CN44 triglycerides, CN46 triglycerides and CN48 triglycerides; from 2.0% to 35.0% by weight of CN50 triglycerides; and from 8.0% to 28.0% by weight of CN54 triglycerides; based on total triglycerides present in the plant-based fat composition; from 42.0 to 48.0 solid fat content at 10° C.; from 14.0 to 20.0 solid fat content at 20° C.; from 5.0 to 10.0 solid fat content at 25° C.; and from 0.4 to 5.0 solid fat content at 30° C.; measured on unstabilized fat according to ISO 8292-1:2008.

In another most preferred aspect, the caramel composition according to the invention comprises from 25% to 40% by weight of a plant-based milk source which is oat milk; from 40% to 50% by weight of a carbohydrate selected from a group consisting of fructose, glucose, syrup thereof, derivatives thereof and mixtures thereof; from 4% to 6% by weight of a sugar alcohol; from 0.005% to 0.015% by weight of butter flavoring; from 0.2% to 0.4% by weight of sunflower lecithin; and from 12% to 19% by weight the plant-based fat composition having from 4.0% to 26.0% by weight of lauric acid (C12:0); from 2.5% to 10.0% by weight of myristic acid (C14:0); from 7.0% to 42.0% by weight of palmitic acid (C16:0); from 4.5% to 17.0% by weight of stearic acid (C18:0); from 18.0% to 45.0% by weight of total palmitic acid (C16:0) and stearic acid (C18:0); from 33.0% to 38.5% by weight of oleic acid (C18:1); and from 3.0% to 9.5% by weight of linoleic acid (C18:2); said percentages of acid referring to acids bound as acyl groups in glycerides of the plant-based fat composition and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 37.0% to 43.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 12.5% to 26.5%; and a percentage of oleic acid (C18:1) on the second position of triglycerides out of total oleic acid (C18:1) (Sn-2 oleic acid %) in the triglycerides of the plant-based fat composition of from 32.0% to 52.0%; from 3.0% to 35.0% by weight of total CN32 triglycerides, CN34 triglycerides, CN36 triglycerides, CN38 triglycerides and CN40 triglycerides; from 16.5% to 26.0% by weight of total CN44 triglycerides, CN46 triglycerides and CN48 triglycerides; from 2.5% to 33.0% by weight of CN50 triglycerides; and from 9.0% to 28.0% by weight of CN54 triglycerides; based on total triglycerides present in the plant-based fat composition; from 42.5 to 47.0 solid fat content at 10° C.; from 15.0 to 19.0 solid fat content at 20° C.; from 5.5 to 9.5 solid fat content at 25° C.; and from 0.4 to 4.5 solid fat content at 30° C.; measured on unstabilized fat according to ISO 8292-1:2008.

The plant-based fat composition of the caramel composition according to the invention preferably comprises from 20% to 70% by weight, more preferably from 25% to 65% by weight and even more preferably from 30% to 60% by weight of an interesterified fat blend comprising at least a lauric fat. Preferably the lauric fat in the interesterified fat blend as disclosed herein is selected from a group consisting of coconut oil, palm kernel oil, a fraction thereof and a mixture thereof. Preferably the lauric fat in the interesterified fat blend as disclosed herein is present in an amount of from 30% to 80% by weight, more preferably from 35% to 75% by weight, based on the weight of the interesterified fat blend.

The term “lauric fat” refers to a fat containing mainly lauric acid (C12:0) such as at least 30% by weight of lauric acid (C12:0), typically derived from sources such as coconut oil or palm kernel oil.

The term “interesterified fat” refers to a fat subjected to a random non-specific redistribution of the fatty acid moieties present in a triglyceride oil over its glycerol moieties.

In a preferred aspect, the plant-based fat composition of the caramel composition according to the invention comprises from 20% to 70% by weight of an interesterified fat blend wherein the interesterified fat blend comprises from 30% to 80% by weight of a lauric fat and 20% to 70% of a fat selected from a group consisting of cocoa butter, shea butter, palm oil, illipe butter, mango oil, sal butter, kokum oil, a fraction thereof and a mixture thereof.

In a more preferred aspect, the plant-based fat composition of the caramel composition according to the invention comprises from 25% to 65% by weight of an interesterified fat blend wherein the interesterified fat blend comprises from 35% to 75% by weight of a lauric fat and 25% to 65% of a fat selected from a group consisting of cocoa butter, shea butter, palm oil, illipe butter, mango oil, sal butter, kokum oil, a fraction thereof and a mixture thereof.

In an even more preferred aspect, the plant-based fat composition of the caramel composition according to the invention comprises from 30% to 60% by weight of an interesterified fat blend wherein the interesterified fat blend comprises from 35% to 75% by weight of a lauric fat selected from a group consisting of coconut oil, palm kernel oil, a fraction thereof and a mixture thereof and 25% to 65% of a fat selected from a group consisting of cocoa butter, shea butter, palm oil, a fraction thereof and a mixture thereof.

The plant-based fat composition of the caramel composition according to the invention preferably further comprises from 35% to 75% by weight, preferably from 40% to 70% by weight of a liquid oil, preferably wherein the liquid oil is selected from the group consisting of sunflower oil, high oleic sunflower oil, high stearic high oleic sunflower oil, high oleic rapeseed oil, high oleic canola oil, high oleic soybean oil, rapeseed oil, rice oil, soybean oil, chia oil, flaxseed oil, corn oil, safflower oil, olive oil, canola oil, grapeseed oil, pumpkin oil, sesame oil, walnut oil, hazelnut oil, coconut oil, palm olein, a fraction thereof and a mixture thereof, more preferably wherein the liquid oil is selected from the group consisting of sunflower oil, high oleic sunflower oil, palm olein, rapeseed oil, a fraction thereof and a mixture thereof. The term “liquid oil” refers to any oil which is liquid or fluid at room temperature such as from 20° C. to 25° C.

In a preferred aspect, the plant-based fat composition of the caramel composition according to the invention comprises from 35% to 75% by weight of a liquid oil and from 20% to 70% by weight of an interesterified fat blend wherein the interesterified fat blend comprises from 30% to 80% by weight of a lauric fat and 20% to 70% of a fat selected from a group consisting of cocoa butter, shea butter, palm oil, illipe butter, mango oil, sal butter, kokum oil, a fraction thereof and a mixture thereof.

In a more preferred aspect, the plant-based fat composition of the caramel composition according to the invention comprises from 40% to 70% by weight of a liquid oil selected from the group consisting of sunflower oil, high oleic sunflower oil, high stearic high oleic sunflower oil, high oleic rapeseed oil, high oleic canola oil, high oleic soybean oil, rapeseed oil, rice oil, soybean oil, chia oil, flaxseed oil, corn oil, safflower oil, olive oil, canola oil, grapeseed oil, pumpkin oil, sesame oil, walnut oil, hazelnut oil, coconut oil, palm olein, a fraction thereof and a mixture thereof and from 25% to 65% by weight of an interesterified fat blend wherein the interesterified fat blend comprises from 35% to 75% by weight of a lauric fat and 25% to 65% of a fat selected from a group consisting of cocoa butter, shea butter, palm oil, illipe butter, mango oil, sal butter, kokum oil, a fraction thereof and a mixture thereof.

In an even more preferred aspect, the plant-based fat composition of the caramel composition according to the invention comprises from 40% to 70% by weight of a liquid oil selected from the group consisting of sunflower oil, high oleic sunflower oil, palm olein, rapeseed oil, a fraction thereof and a mixture thereof and from 30% to 60% by weight of an interesterified fat blend wherein the interesterified fat blend comprises from 35% to 75% by weight of a lauric fat selected from a group consisting of coconut oil, palm kernel oil, a fraction thereof and a mixture thereof and 25% to 65% of a fat selected from a group consisting of cocoa butter, shea butter, palm oil, a fraction thereof and a mixture thereof.

The invention also relates to a process for preparing a caramel product, comprising the steps of emulsifying the caramel composition according to the invention by mixing; and heat treating the emulsified caramel composition at a temperature of at least 100° C. for caramelization.

The term “caramelization” refers to a process of browning of carbohydrate used extensively in cooking at a high temperature to result in sweet flavour and brown coloring.

In a preferred aspect, the process for preparing a caramel product comprises the steps of emulsifying the caramel composition according to the invention by mixing; and heat treating the emulsified caramel composition at a temperature of from 105° C. to 220° C. for caramelization.

In a more preferred aspect, the process for preparing a caramel product comprises the steps of emulsifying the caramel composition according to the invention by mixing; and heat treating the emulsified caramel composition at a temperature of from 108° C. to 200° C. for caramelization.

In an even more preferred aspect, the process for preparing a caramel product comprises the steps of emulsifying the caramel composition according to the invention by mixing; and heat treating the emulsified caramel composition at a temperature of from 110° C. to 180° C. for caramelization.

In a most preferred aspect, the process for preparing a caramel product comprises the steps of emulsifying the caramel composition according to the invention by mixing; and heat treating the emulsified caramel composition at a temperature of from 110° C. to 170° C. for caramelization.

The invention also relates to a caramel product obtained or obtainable by the process according to the invention.

The invention also relates to a use of the caramel product according to the invention in a food product, preferably in a confectionery product and more preferably in a pudding, a candy bar, a snack bar, a confectionery filling, an ice-cream, a frozen yoghurt, a candy, a bonbon, a dessert, a toffee, a nougat, a sauce, a coating or a tablet.

The listing or discussion of an apparently prior-published document in this specification should not necessarily be taken as an acknowledgement that the document is part of the state of the art or is common general knowledge.

Preferences and options for a given aspect, embodiment, feature or parameter of the invention should, unless the context indicates otherwise, be regarded as having been disclosed in combination with any and all preferences and options for all other aspects, embodiments, features and parameters of the invention.

As will be understood by one skilled in the art, for any and all purposes, particularly in terms of providing a written description, all ranges disclosed herein also encompass any and all possible subranges and combinations of subranges thereof. Any listed ranges can be easily recognized as sufficiently describing and enabling the same range being broken down into at least equal halves, thirds, quarters, fifths, tenths, etc. As will also be understood by one skilled in the art all language such as “up to”, “at least”, “greater than”, “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The following non-limiting examples illustrate the invention and do not limit its scope in any way. In the examples and throughout this specification, all percentages, parts and ratios are by weight unless indicated otherwise.

### EXAMPLES

Throughout these examples:
US-Nx refers to solid fat content determined by NMR on unstabilised fat measured at x ° C. (ISO 8292-1:2008);
Cx:y refers to a fatty acid having x carbon atoms and y double bonds; levels determined by GC-FAME (ISO 12966-2:2014 and ISO 12966-4:2015);
percentages of acid referring to acids bound as acyl groups in glycerides and being based on the total weight of C8 to C24 fatty acids;
SAFA refers to saturated fatty acids;
MUFA refers to mono-unsaturated fatty acids;
PUFA refers to poly-unsaturated fatty acids;
IV FAME refers to calculated iodine value according to AOCS Cd 1c-85;
TRANS refers to trans fatty acids: unsaturated fatty acids having a double bond in a trans arrangement;
Diglyceride refers to the percentage of diglyceride or diacylglycerol (DAG) in the composition measured by straight phase HPLC and two forms of diglycerides exist, 1,2-diglyceride (1,2-diacylglycerols) and 1,3-diglyceride (1,3-diacylglycerols);
CNxx, refers to a triglyceride having xx carbon atoms (excluding the carbon atoms from the glycerol, as is standard practice), levels determined by GC with pre-treatment to remove the diglycerides eventually (AOCS Ce 5-86);
SN-2 of total lauric acid and myristic acid % refers to the percentage of total lauric acid (C12:0) and myristic acid (C14:0) present at the 2-position of the triglyceride in comparison to the percentage of total lauric acid (C12:0) and myristic acid (C14:0) in the fat sample. The distribution of fatty acids in triglyceride is determined based on joint JOCS/AOCS official method Ch 3a-19. The percentage of total lauric acid (C12:0) and myristic acid (C14:0) residues in the 2-position is determined by finding: (a) the total lauric acid (C12:0) and myristic acid (C14:0) content of the fat sample by GC-FAME (ISO 12966-2:2014 and ISO 12966-4: 2015) being based on the total weight of C8 to C24 fatty acids; and (b) the total lauric acid (C12:0) and myristic acid (C14:0) content of the 2-position by GC-FAME (ISO 12966-2:2014 and ISO 12966-4:2015) in 2-monoglyceride being based on the total weight of C8 to C24 fatty acids after the transesterification reaction of triacylglycerols with ethanol by immobilized lipase and the isolation with preparative straight phase HPLC. The Sn-2 of total lauric acid and myristic acid % is thus ((b)×100)/((a)×3) %;
SN-2 of total palmitic acid and stearic acid % refers to the percentage of total palmitic acid (C16:0) and stearic acid (C18:0) present at the 2-position of the triglyceride in comparison to the percentage of total palmitic acid (C16:0) and stearic acid (C18:0) in the fat sample. The distribution of fatty acids in triglyceride is determined based on joint JOCS/AOCS official method Ch 3a-19. The percentage of total palmitic acid (C16:0) and stearic acid (C18:0) residues in the 2-position is determined by finding: (a) the total palmitic acid (C16:0) and stearic acid (C18:0) content of the fat sample by GC-FAME (ISO 12966-2:2014 and ISO 12966-4:2015) being based on the total weight of C8 to C24 fatty acids; and (b) the total palmitic acid (C16:0) and stearic acid (C18:0) content of the 2-position by GC-FAME (ISO 12966-2:2014 and ISO 12966-4:2015) in 2-monoglyceride being based on the total weight of C8 to C24 fatty acids after the transesterification reaction of triacylglycerols with ethanol by immobilized lipase and the isolation with preparative straight phase HPLC. The Sn-2 of total palmitic acid and stearic acid % is thus ((b)×100)/((a)×3) %; and
SN-2 of oleic acid % refers to the percentage of oleic acid (C18:1) present at the 2-position of the triglyceride in comparison to the percentage of oleic acid (C18:1) in the fat sample. The distribution of fatty acids in triglyceride is determined based on joint JOCS/AOCS official method Ch 3a-19. The percentage of oleic acid (C18:1) residues in the 2-position is determined by finding: (a) the oleic acid (C18:1) content of the fat sample by GC-FAME (ISO 12966-2:2014 and ISO 12966-4:2015) being based on the total weight of C8 to C24 fatty acids; and (b) the oleic acid (C18:1) content of the 2-position by GC-FAME (ISO 12966-2:2014 and ISO 12966-4:2015) in 2-monoglyceride being based on the total weight of C8 to C24 fatty acids after the transesterification reaction of triacylglycerols with ethanol by immobilized lipase and the isolation with preparative straight phase HPLC. The Sn-2 of oleic acid % is thus ((b)×100)/((a)×3) %.

### Example 1—Preparation of Fat Composition 1 to 3 and Comparative Fat Compositions 1 and 2

A fat blend of 25% by weight of refined cocoa butter and 75% by weight of coconut oil was chemically interesterified using sodium methoxide as catalyst followed by refining including bleaching and deodorization to form an interesterified fat blend A as hardstock. Fat composition 1 was a blend of 57.6% by weight of the interesterified fat blend A, 12.6% by weight of coconut oil and 29.8% by weight of high oleic sunflower oil.

A fat blend of 35% by weight of refined palm kernel oil and 65% by weight of palm stearin with iodine value of about 35 was enzymatically interesterified using Lipozyme® TL IM as catalyst followed by refining including bleaching and deodorization to form an interesterified fat blend B as hardstock. Fat composition 2 was a blend of 30% by weight of the interesterified fat blend B and 70% by weight of palm olein with iodine value of about 56.

A fat blend of 40% by weight of refined coconut oil and 60% by weight of refined shea butter was chemically interesterified using sodium methoxide as catalyst followed by refining including bleaching and deodorization to form an interesterified fat blend C as hardstock. Fat composition 3 was a blend of 60% by weight of the interesterified fat blend C, 20% by weight of coconut oil and 20% by weight of sunflower oil.

Comparative fat composition 1 was a blend of 51.2% by weight of the interesterified fat blend A, 11.2% by weight of coconut oil and 37.6% by weight of high oleic sunflower oil.

Comparative fat composition 2 was a blend of 48% by weight of palm soft mid fraction having an iodine value about 47 and 52% by weight of palm olein fraction having an iodine value about 52.

The analytical results of Fat composition 1, Fat composition 2, Fat composition 3, Comparative fat composition 1 and Comparative fat composition 2 are shown in Table 1.

TABLE 1
Analytical results of Fat composition 1, Fat composition
2, Fat composition 3, Comparative fat composition
1 and Comparative fat composition 2.

| | | | | Compar- | Compar- |
|---|---|---|---|---|---|
| | | | | ative | ative |
| | Fat com- | Fat com- | Fat com- | fat com- | fat com- |
| | position 1 | position 2 | position 3 | position 1 | position 2 |
| US-N10 | 43.1 | 46.6 | 42.8 | 36.2 | 52.1 |
| US-N20 | 16.8 | 18.6 | 15.4 | 13.3 | 25.8 |
| US-N25 | 5.7 | 9.4 | 5.9 | 4.2 | 14.6 |
| US-N30 | 0.4 | 4.3 | 2.3 | 0.1 | 8.6 |
| US-N35 | 0.0 | 0.3 | 0.5 | 0.0 | 4.4 |
| C8:0 | 3.6 | 0.4 | 2.8 | 3.2 | 0.0 |
| C10:0 | 2.9 | 0.4 | 2.4 | 2.6 | 0.0 |
| C12:0 | 25.3 | 5.0 | 19.5 | 21.6 | 0.3 |
| C14:0 | 9.8 | 2.5 | 7.8 | 8.7 | 1.0 |
| C16:0 | 10.1 | 40.4 | 7.1 | 9.6 | 44.4 |
| C16:1 | 0.1 | 0.2 | 0.1 | 0.1 | 0.2 |
| C17:0 | 0.1 | 0.1 | 0.0 | 0.1 | 0.1 |
| C18:0 | 7.9 | 4.5 | 16.5 | 7.6 | 5.5 |
| C18:1 | 35.2 | 36.7 | 38.2 | 40.7 | 38.9 |
| C18:2 | 3.9 | 9.1 | 4.4 | 4.5 | 8.5 |
| C18:3 | 0.1 | 0.2 | 0.1 | 0.1 | 0.2 |
| C20:0 | 0.4 | 0.4 | 0.6 | 0.4 | 0.4 |
| C20:1 | 0.1 | 0.1 | 0.2 | 0.1 | 0.1 |
| C22:0 | 0.4 | 0.1 | 0.3 | 0.4 | 0.1 |
| C24:0 | 0.1 | 0.1 | 0.1 | 0.2 | 0.1 |
| C16:0 + | 18.0 | 44.9 | 23.6 | 17.2 | 49.9 |
| C18:0 | | | | | |
| SAFA | 60.6 | 53.7 | 57.1 | 54.5 | 52.0 |
| MUFA | 35.5 | 37.0 | 38.4 | 40.9 | 39.2 |
| PUFA | 3.9 | 9.3 | 4.4 | 4.5 | 8.7 |
| IV FAME | 37.3 | 48.1 | 40.8 | 43.1 | 49.0 |
| TRANS | 0.1 | 0.2 | 0.1 | 0.1 | 0.2 |
| CN26 | 0.2 | 0.1 | 0.1 | 0.2 | 0.0 |
| CN28 | 0.5 | 0.1 | 0.3 | 0.5 | 0.0 |
| CN30 | 1.3 | 0.2 | 1.2 | 1.2 | 0.0 |
| CN32 | 4.0 | 0.2 | 2.8 | 3.4 | 0.0 |
| CN34 | 5.3 | 0.4 | 3.9 | 4.7 | 0.0 |
| CN36 | 8.3 | 1.0 | 5.5 | 7.5 | 0.0 |
| CN38 | 9.2 | 1.1 | 6.7 | 8.4 | 0.0 |
| CN40 | 8.2 | 2.3 | 5.0 | 7.3 | 0.1 |
| CN42 | 10.0 | 2.8 | 9.4 | 8.9 | 0.1 |
| CN44 | 7.0 | 4.4 | 7.6 | 6.3 | 0.1 |
| CN46 | 5.4 | 5.4 | 5.7 | 4.8 | 0.8 |
| CN48 | 5.0 | 6.8 | 12.5 | 4.5 | 6.7 |
| CN50 | 2.5 | 32.5 | 5.4 | 2.4 | 42.5 |
| CN52 | 5.8 | 33.5 | 6.6 | 6.7 | 37.9 |
| CN54 | 26.0 | 9.0 | 27.3 | 31.8 | 11.3 |
| CN56 | 0.6 | 0.2 | 0.0 | 0.7 | 0.5 |
| CN58 | 0.6 | 0.0 | 0.0 | 0.7 | 0.0 |
| CN32 + | 35.0 | 5.0 | 23.9 | 31.3 | 0.1 |
| CN34 + | | | | | |
| CN36 + | | | | | |
| CN38 + | | | | | |
| CN40 | | | | | |
| CN44 + | 17.4 | 16.6 | 25.8 | 15.6 | 7.6 |
| CN46 + | | | | | |
| CN48 | | | | | |
| Diglyceride | 2.8 | 7.0 | 3.8 | 2.7 | 7.2 |
| 1,2- | 0.9 | 2.5 | 1.2 | 0.9 | 2.2 |
| diglyceride | | | | | |
| 1,3- | 1.9 | 4.5 | 2.6 | 1.8 | 5.0 |
| diglyceride | | | | | |

The method based on thin-layer chromatography (TLC) and the partial hydrolysis of triglyceride with Grignard reagent was used to quantify the fatty acid esterified at the SN-2 position of triglycerides in Fat compositions 1-3 and Comparative fat compositions 1-2 further by GC-FAME (ISO 12966-2:2014 and ISO 12966-4:2015) being based on the total weight of C8 to C24 fatty acids. The analytical results are shown in Table 2.

TABLE 2
Fatty acid composition on SN-2 position of Fat composition
1, Fat composition 2, Fat composition 3, Comparative fat
composition 1 and Comparative fat composition 2.

| | | | | Compar- | Compar- |
|---|---|---|---|---|---|
| | | | | ative | ative |
| | Fat com- | Fat com- | Fat com- | fat com- | fat com- |
| | position 1 | position 2 | position 3 | position 1 | position 2 |
| C8:0 | 3.9 | 0.3 | 2.4 | 3.4 | 0.0 |
| C10:0 | 3.2 | 0.3 | 2.3 | 2.8 | 0.0 |
| C12:0 | 31.3 | 6.2 | 28.3 | 27.9 | 0.5 |
| C14:0 | 8.9 | 2.2 | 6.7 | 7.9 | 0.6 |
| C16:0 | 7.7 | 16.2 | 4.5 | 7.0 | 15.9 |
| C16:1 | 0.1 | 0.2 | 0.0 | 0.1 | 0.1 |
| C17:0 | 0.0 | 0.0 | 0.0 | 0.0 | 0.0 |
| C18:0 | 6.4 | 1.1 | 14.0 | 5.8 | 1.3 |
| C18:1 | 34.2 | 56.7 | 37.2 | 40.2 | 64.7 |
| C18:2 | 4.0 | 16.5 | 4.4 | 4.5 | 16.5 |
| C18:3 | 0.1 | 0.2 | 0.0 | 0.1 | 0.2 |
| C20:0 | 0.2 | 0.0 | 0.1 | 0.2 | 0.0 |
| C20:1 | 0.0 | 0.0 | 0.0 | 0.1 | 0.0 |
| C22:0 | 0.0 | 0.0 | 0.0 | 0.0 | 0.0 |
| C24:0 | 0.0 | 0.0 | 0.0 | 0.0 | 0.0 |
| C12:0 + | 40.2 | 8.4 | 35.0 | 35.9 | 1.1 |
| C14:0 | | | | | |
| C16:0 + | 14.1 | 17.3 | 18.5 | 12.8 | 17.2 |
| C18:0 | | | | | |
| Sn-2 total | 38.2% | 37.3% | 42.7% | 39.4% | 27.3% |
| lauric acid | | | | | |
| and | | | | | |
| myristic acid | | | | | |
| % = total | | | | | |
| lauric acid | | | | | |
| and | | | | | |
| myristic acid | | | | | |
| on SN-2 | | | | | |
| position/ | | | | | |
| (total | | | | | |
| lauric acid | | | | | |
| and myristic | | | | | |
| acid × 3)% | | | | | |
| Sn-2 total | 26.1% | 12.9% | 26.1% | 24.7% | 11.5% |
| palmitic acid | | | | | |
| and | | | | | |
| stearic acid | | | | | |
| % = total | | | | | |
| palmitic acid | | | | | |
| and | | | | | |
| stearic acid | | | | | |
| on SN-2 | | | | | |
| position/ | | | | | |
| (total | | | | | |
| palmitic acid | | | | | |
| and stearic | | | | | |
| acid × 3)% | | | | | |
| Sn-2 oleic | 32.4% | 51.5% | 32.5% | 32.9% | 55.5% |
| acid % = | | | | | |
| oleic acid | | | | | |
| on SN-2 | | | | | |
| position/ | | | | | |
| (total oleic | | | | | |
| acid × 3)% | | | | | |

Anhydrous butter fat was obtained from Friesland Campina (Amersfoort, The Netherland) was used for preparing the reference caramel composition in the following. The solid fat content profile of the anhydrous butter fat is disclosed here below in Table 3.

TABLE 3
Analytical results of anhydrous butter fat.

| | Anhydrous |
|---|---|
| | butter fat |
| US-N10 | 50.8 |
| US-N20 | 20.0 |
| US-N25 | 12.3 |
| US-N30 | 6.6 |
| US-N35 | 0.0 |

### Example 2—Production and Recipe of Caramel Compositions

Caramel compositions (Reference caramel composition, Caramel composition 1, Comparative caramel composition 1 and Comparative caramel composition 2 as listed in Table 4) were prepared.

TABLE 4
Overview of caramel compositions.

| | Reference | | Comparative | Comparative |
|---|---|---|---|---|
| | caramel com- | Caramel Com- | caramel com- | caramel com- |
| Composition | position | position 1 | position 1 | position 2 |
| Fat | Anhydrous | Fat com- | Comparative | Comparative |
| composition | butter fat | position 1 | fat com- | fat com- |
| | | | position 1 | position 2 |

The recipe of caramel compositions is presented in Table 5.

TABLE 5
Recipe of caramel compositions.

| | Weight |
|---|---|
| Ingredient | percentage % |
| Condensed milk | 37.89 |
| Fat composition | 16.93 |
| Milky butter flavoring | 0.01 |
| Glucose syrup DE (dextrose | 36.89 |
| equivalent) 42 | |
| Sorbitol syrup | 4.99 |
| Inverted sugar syrup | 2.99 |
| Sunflower lecithin | 0.30 |
| Total | 100.00 |

Full cream sweetened condensed milk (SCM) (fat content: 9% by weight) was obtained from Friesche Vlag (Amersfoort, The Netherland). Glucose syrup was obtained from Dawn Food (Breda, The Netherland). Sorbitol syrup was obtained from Cargill (Bergen op zoom, The Netherland). Inverted sugar syrup was obtained from FunCakes (Amsterdam, The Netherland). Milk butter flavoring was obtained from Mane (Germany). Sunflower lecithin (BungeMaxx S-1000) was obtained from Bunge Loders Croklaan (Wormerveer, The Netherland).

Initially, the prepared fat compositions were completely melted and mixed with the flavoring and sunflower lecithin. The rest of ingredients were kept in a 50° C. cabinet prior to processing to make sirups more fluid. The ingredients for the amount 1500 g of each caramel composition were weighed according to Table 5 and mixed in a stainless-steel sauce pot. Caramel premix was then heated until 111° C. under constant manual stirring in the gas stove with the level of flame constant throughout the entire cooking process. The cooking timing and the foam occurring while cooking was recorded.

As soon as the caramel reached 111° C., the caramel pan was placed into a cold-water bath at 17° C. and cooled down while stirring to 90° C. The caramel product was then removed from the cold-water bath and allow to cool down further while manually stirring. When the temperature reached 75° C., the caramel mass was immediately poured into several different molds and containers. Samples for cold flow testing were poured into cylinder plastic molds. Samples for sensory test and oil surface observation were poured into 20 ml sample cups with lids. Finally, 2.5 mm thin layer of caramel was made between fat free paper. The presence of threads and the visual consistency of the caramel was observed and recorded after storing at room temperature for 20 minutes.

The cooking time for each product is summarized in Table 6 below.

TABLE 6
Cooking time for caramel products.

| | Cooking |
|---|---|
| | time (minutes) |
| Reference caramel product | 36 |
| Caramel product 1 | 37 |
| Comparative caramel product 1 | 37 |
| Comparative caramel product 2 | 35 |

### Example 3—Evaluation of the Caramel Products

Moisture content (% w/w) for all caramel products was determined by Karl Fisher titration. Water activity was determined using Novasina AW SPRINT instrument (Lachen, Switzerland) set to 25° C. Table 7 below presents water activity (aw) and moisture content of the caramel products.

TABLE 7
Water activity (a_{w}) and moisture (%) of the caramel products.

| | Water | Moisture |
|---|---|---|
| | activity (a_{w}) | (%) |
| Reference caramel product | 0.639 | 10.30 |
| Caramel product 1 | 0.593 | 10.00 |
| Comparative caramel product 1 | 0.605 | 9.98 |
| Comparative caramel product 2 | 0.582 | 9.59 |

Based on the similar cooking time and temperature, and the resulting similar moisture content and water activity in all the caramel products, it could be assumed that the extent of caramelization in the different samples is the same, as is the caramelization contribution to flavor and color for the different samples.

Cold flow is described as flow of an amorphous material at low temperatures due to the force of gravity. Cold flow measurement were evaluated in triplicate. Freshly prepared hot caramel products were molded into cylinder plastic molds (diameter=25 mm; height 22.5 mm) and held overnight at 20° C. to allow for equilibration of products and crystallization of fat. Products were then demolded, and initial diameters of each product were measured using caliper (Mitutoyo, Japan). The caramel products were stored into hermetically sealed containers over saturated salt solution of Mg(NO3) 2 (aw=0.55) at 20° C. for 24 h. Final diameter at the base of the products was measured and cold flow was calculated as the precent change in base area. The results were subjected to a multiple analysis of variance (ANOVA) at the 95% confidence level.

Table 8 shows the cold flow of all the caramel products. The cold flow of Caramel product 1 was not significantly different to Reference caramel product (p<0.05). In contrast, the cold flow of Comparative caramel product 1 and Comparative caramel product 2 were significantly different compared to Reference caramel product (p>0.05). It could be concluded that Caramel product 1 has a desirable texture and consistency very similar to Reference caramel product.

TABLE 8
Cold flow of the caramel products.

| | Cold |
|---|---|
| | flow (%) |
| Reference caramel product | 142 |
| Caramel product 1 | 144 |
| Comparative caramel product 1 | 203 |
| Comparative caramel product 2 | 131 |

Observation of the caramel products included oil separation. The caramel products in cups were stored at 20° C. and cycling temperature 15/25° C. every 12 hours for 1 week. Observation was made on the presence of oil on the caramel surface after a week in the incubator and no oil separation was observed in any caramel product.

17 panelists participated in the sensory evaluation where the test environment was in a room at around 20° C. The samples (in caramel cup of 28 ml) were presented with a series of coded test sample and one sample was the blind reference which was presented as another product sample. The panelists were asked to assess multiple pairs where each time the reference sample and then the coded test sample/blind reference were assessed. The order of sample presentation was balanced across the panel and session. The panelists were asked to test the control sample first, then cleanse the mouth with lukewarm water, and then test the coded test sample. They were asked to indicate the magnitude of the difference between the two samples using a 5-point category scale for the attributes: hardness, chewiness, stickiness, flavor intensity, and flavor release time. These attributes are described in Table 9 as below.

TABLE 9
Attributes of caramel products.

| Attribute | Definition | Scores |
|---|---|---|
| Hardness | Perception of required | Extremely softer: −3 |
| | force to achieve a | Much softer: −2 |
| | deformation (soft - | Softer: −1 |
| | hard) | Equal: 0 |
| | | Harder: +1 |
| | | Much harder: +2 |
| | | Extremely harder: +3 |
| Chewiness | The condition of | Extremely less: −3 |
| | necessitating chewing | Much less: −2 |
| | or of being difficult | Less chewy: −1 |
| | to chew | Equal: 0 |
| | | More chewy: +1 |
| | | Much more: +2 |
| | | Extremely more: +3 |
| Stickiness | The tendency to adhere | Extremely stickier: −3 |
| | to the palate, teeth, | Much less sticker: −2 |
| | and tongue. | Less stickier: −1 |
| | | Equal: 0 |
| | | Stickier: +1 |
| | | Much stickier: +2 |
| | | Extremely stickier: +3 |
| Waxiness | The extent to which | Extremely less: −3 |
| | the fat remains and | Much less: −2 |
| | coats your mouth | Less waxy: −1 |
| | | Equal: 0 |
| | | Waxier: +1 |
| | | Much waxier: +2 |
| | | Extremely waxier: +3 |
| Flavor | The time it takes before | Extremely slower: −3 |
| release time | any caramel flavor is | Much slower: −2 |
| | released in the mouth. | Slower: −1 |
| | | Equal: 0 |
| | | Faster: +1 |
| | | Much faster: +2 |
| | | Extremely faster: +3 |
| Flavor impact: | The intensity of the | Extremely less: −3 |
| caramelic | caramel flavor which | Much less: −2 |
| | is released from | Less caramelic: −1 |
| | the sample. | Equal: 0 |
| | | More caramelic: +1 |
| | | Much more: +2 |
| | | Extremely more: +3 |
| Flavor | The intensity of the | Extremely less: −3 |
| impact: buttery | buttery flavor which | Much less: −2 |
| | is released from | Less buttery: −1 |
| | the sample. | Equal: 0 |
| | | More buttery: +1 |
| | | Much more: +2 |
| | | Extremely more: +3 |

The mean panel data are shown in Table 10 below. The mean for Reference caramel product (blind control) is a measure of the placebo effect, as it is the result when no change was applied and the sample was in fact a duplicate control.

TABLE 10
Mean panel sensory data.

| | Reference | | Comparative | Comparative |
|---|---|---|---|---|
| | caramel | Caramel | caramel | caramel |
| Attribute | product | product 1 | product 1 | product 2 |
| Hardness | 0.1 | 1.1 | 1.1 | 2.0 |
| Chewiness | 0.1 | 1.0 | 0.5 | 1.4 |
| Stickiness | 0.2 | 0.6 | 0.7 | 0.3 |
| Waxiness | 0.0 | 0.1 | 0.5 | 0.3 |
| Flavor | −0.1 | −0.3 | −0.7 | −1.5 |
| release time | | | | |
| Flavor | 0.3 | −0.5 | −0.6 | −1.5 |
| impact: | | | | |
| Caramelic | | | | |
| Flavor | 0.1 | −0.5 | −0.5 | −0.7 |
| impact: | | | | |
| Butter | | | | |

It could be observed that Comparative caramel product 2 has an undesirably high harness and chewiness compared to Reference caramel product. In addition, Comparative caramel product 2 had also a slower flavor release and negative flavor impacts compared to Reference caramel product. Further, Comparative caramel product 1 had an undesirably high waxiness and relatively slow flavor release. Caramel product 1 using a plant-based fat composition had very similar organoleptic properties as Reference caramel product using dairy butter fat.

1. A caramel composition comprising:
a dairy milk source and/or a plant-based milk source;
a carbohydrate; and
a plant-based fat composition wherein the plant-based fat composition has:
at most 40.0% by weight of oleic acid (C18:1); and
from 17.5% to 49.5% by weight of total palmitic acid (C16:0) and stearic acid (C18:0);
said percentages of acid referring to acids bound as acyl groups in glycerides of the plant-based fat composition and being based on the total weight of C8 to C24 fatty acids;
a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat of from 30.0% to 55.0%;
at most 30.0% by weight of CN54 triglycerides;
based on total triglycerides present in the plant-based fat composition.

2. The caramel composition according to claim 1, comprising:
from 5% to 50% by weight of the dairy milk source and/or the plant-based milk source; and/or
from 5% to 80% by weight of the carbohydrate; and/or
from 3% to 25% by weight the plant-based fat composition.

3. The caramel composition according to claim 1, wherein the dairy milk source of the caramel composition is selected from a group consisting of whole milk, skimmed milk, butter milk, condensed milk, milk drink, reconstituted milk, evaporated milk, cream, heavy cream, light cream, double cream, derivatives thereof and mixtures thereof.

4. The caramel composition according to claim 1, wherein the carbohydrate of the caramel composition is selected from a group consisting of fructose, glucose, sucrose, maltose, starch, syrup thereof, derivatives thereof and mixtures thereof.

5. The caramel composition according to claim 1, wherein the caramel composition further comprises from 1% to 10% by weight of a sugar alcohol.

6. The caramel composition according to claim 1, further comprising one or more ingredients selected from emulsifier, vanillin, salt, sodium bicarbonate, calcium carbonate, colorant and flavoring.

7. The caramel composition according to claim 6, wherein the caramel composition further comprises at most 0.20% by weight of butter flavoring.

8. The caramel composition according to claim 6, wherein the caramel composition further comprises at most 1.0% by weight of lecithin.

9. The caramel composition according to claim 1, wherein the plant-based fat composition of the caramel composition has:
from 1.0% to 35.0% by weight of lauric acid (C12:0); and/or
from 1.0% to 15.0% by weight of myristic acid (C14:0); and/or
from 5.0% to 50.0% by weight of palmitic acid (C16:0); and/or
from 3.0% to 25.0% by weight of stearic acid (C18:0); and/or
from 18.0% to 48.0% by weight of total palmitic acid (C16:0) and stearic acid (C18:0); and/or
from 20.0% to 39.0% by weight of oleic acid (C18:1); and/or
at most 12.0% by weight of linoleic acid (C18:2);
said percentages of acid referring to acids bound as acyl groups in glycerides of the plant-based fat composition and being based on the total weight of C8 to C24 fatty acids.

10. The caramel composition according to claim 1, wherein the plant-based fat composition of the caramel composition has:
a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat composition of from 32.0% to 50.0% and/or
a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat composition of from 10.0% to 35.0% and/or
a percentage of oleic acid (C18:1) on the second position of triglycerides out of total oleic acid (C18:1) (Sn-2 oleic acid %) in the triglycerides of the plant-based fat composition of from 25.0% to 60.0%.

11. The caramel composition according to claim 1, wherein the plant-based fat composition of the caramel composition has:
from 0.5% to 40.0% by weight of total CN32 triglycerides, CN34 triglycerides, CN36 triglycerides, CN38 triglycerides and CN40 triglycerides; and/or
from 5.0% to 30.0% by weight of total CN44 triglycerides, CN46 triglycerides and CN48 triglycerides; and/or
from 5.0% to 30.0% by weight of CN54 triglycerides; based on total triglycerides present in the plant-based fat composition.

12. The caramel composition according to claim 1, wherein the plant-based fat composition of the caramel composition has:
from 40.0 to 50.0 solid fat content at 10° C.; and/or
from 12.0 to 25.0 solid fat content at 20° C.; and/or
from 2.0 to 14.0 solid fat content at 25° C.; and/or
from 0.2 to 8.0 solid fat content at 30° C.;
measured on unstabilized fat according to ISO 8292-1:2008.

13. The caramel composition according to claim 1, wherein the plant-based fat composition has an iodine value (IV) of from 25 to 60.

14. A process for preparing a caramel product, comprising the steps of:
emulsifying the caramel composition according to claim 1 by mixing; and
heat treating the emulsified caramel composition at a temperature of at least 100° C. for caramelization.

15. A caramel product obtainable by the process according to claim 14.

16. A food product comprising a caramel product according to claim 15.

17. The food product according to claim 16, wherein the food product is a confectionary food product selected from the group consisting of a pudding, a candy bar, a snack bar, a confectionery filling, an ice-cream, a frozen yoghurt, a candy, a bonbon, a dessert, a toffee, a nougat, a sauce, a coating, and a tablet.
